(19) United States
(12) Patent Application Publication
(10) Pub. No.: US 2021/0069598 A1
(43) Pub. Date: Mar. 11, 2021

(54) PROGRAM, INFORMATION PROCESSING APPARATUS, AND GAME SYSTEM

(71) Applicant: BANDAI CO., LTD., Tokyo (JP)

(72) Inventors: Takashi NAGURA, Tokyo (JP); Hideto Kotani, Tokyo (JP); Nao Yamaguchi, Tokyo (JP); Masahiko Saito, Tokyo (JP); Hyunsoo Lee, Tokyo (JP)

(21) Appl. No.: 17/015,447

(22) Filed: Sep. 9, 2020

(30) Foreign Application Priority Data
Sep. 9, 2019 (JP) 2019-164060

(51) Int. Cl. A63F 13/795

(52) U.S. Cl. CPC A63F 13/795

(57) ABSTRACT

Provided is a program, an information processing apparatus, and a game system enabling a game to continue to be entertaining to users. Provided is a program causing a computer to execute a competition game using a first game element, and to function as: a relationship setting unit capable of setting a first relationship and a second relationship between own player and another player; and a relationship control unit capable of performing control to enable setting of a third relationship between the own player and another player in the first relationship with the own player, and to disable the setting of the third relationship between the own player and another player in the second relationship with the own player.

### CROSS REFERENCES TO RELATED APPLICATIONS

This application claims priority to Japanese Patent Application No. 2019-164060 filed in the Japan Patent Office on Sep. 9, 2019, the entire contents of which are incorporated herein by reference.

### BACKGROUND

### Field of the Invention

The present invention relates to programs, terminals, gaming systems, and game management devices.

### Description of the Related Art

A known information processing apparatus executes information processing related to a game in which a predetermined relationship can be set between players (JP-A-2017-140144, for example). Examples of this predetermined relationship include an acquaintance relationship which is a friend relationship described later.

By establishing the predetermined relationship such as a friend relationship, one can enter a special competition or is given a reward in the game.

### SUMMARY

Unlimitedly allowing a request for the predetermined relationship such as the friend relationship compromises the original spirit of establishing the predetermined relationship, and may cause trouble between users, that is, the players. As a result, the game might become no longer entertaining to the user.

In view of this, the present invention provides a program, an information processing apparatus, and a game system enabling a game to continue to be entertaining to the user.

An aspect of the present invention provides a program causing a computer to execute a competition game using a first game element, and to function as: a relationship setting unit capable of setting a first relationship or a second relationship between own player and another player; and a relationship control unit capable of performing control to enable setting of a third relationship between the own player and another player in the first relationship with the own player, and to disable the setting of the third relationship between the own player and another player in the second relationship with the own player.

An aspect of the present invention provides an information processing apparatus to execute a competition game using a first game element, the information processing apparatus including: a relationship setting unit capable of setting a first relationship or a second relationship between own player and another player; and a relationship control unit capable of performing control to enable setting of a third relationship between the own player and another player in the first relationship with the own player, and to disable the setting of the third relationship between the own player and another player in the second relationship with the own player.

An aspect of the present invention provides an information processing apparatus to control a competition game using a first game element, the information processing apparatus including: a relationship setting unit capable of setting a first relationship between players of a game or a second relationship between the players; and a control unit capable of performing control to enable setting of a third relationship between the players in the first relationship and to disable the setting of the third relationship between the players in the second relationship.

An aspect of the present invention provides a game system including: a unit issuing a request for setting a first relationship between players of a game or a second relationship between the players; a unit setting the first relationship between the players of the game or a second relationship between the players in response to the request; and a unit capable of performing control to enable setting of a third relationship between the players in the first relationship and to disable the setting of the third relationship between the players in the second relationship.

According to the present invention, it is possible to enable a game to continue to be entertaining to users.

### BRIEF DESCRIPTION OF THE DRAWINGS

FIG. 1 is a diagram illustrating an example of an overall configuration of a game system according to the present embodiment;

FIG. 2 is a diagram illustrating an example of an apparatus configuration of a smartphone that is an example of a player terminal;

FIG. 3 is a diagram illustrating an example of a screen displayed on a display 11 of the player terminal 1 during a standby phase or a card use preparation phase of a competition game;

FIG. 4 is a diagram illustrating how a card is operated;

FIG. 5 is a block diagram illustrating an example of a functional configuration of the player terminal 1;

FIG. 6 is a diagram illustrating an example of a battle menu;

FIG. 7 is a diagram illustrating an example of a list of friends in a friend relationship;

FIG. 8 is a diagram illustrating an example of a league match selection screen;

FIG. 9 is a diagram illustrating an example of a league match hold screen;

FIG. 10 is a diagram illustrating an example of a league match invitation screen;

FIG. 11 is a diagram illustrating an example of a league match invitation screen;

FIG. 12 is a diagram illustrating an example of card setting data;

FIG. 13 is a diagram illustrating an example of deck setting data;

FIG. 14 is a diagram illustrating an example of buddy setting data about a player A;

FIG. 15 is a diagram illustrating an example of player data;

FIG. 16 is a diagram illustrating an example of friend data;

FIG. 17 is a block diagram illustrating an example of a functional configuration of a game server 2;

FIG. 18 is a diagram illustrating an example of user information data;

FIG. 19 is an overall sequence diagram illustrating operations between the player terminal 1 and the game server 2;

FIG. 20 is a diagram illustrating an example of league match competition result displayed on the terminal 1 of the player A;

FIG. 21 is a diagram illustrating an example of league match competition result displayed on the terminal 1 of a player C; and

FIG. 22 is a diagram illustrating a display example of a friend accept screen displayed on the terminal 1 of the player.

### DETAILED DESCRIPTION

The present disclosure now will be described more fully hereinafter with reference to the accompanying drawings in which some but not all embodiments of the disclosure are shown. Indeed, these embodiments may be embodied in many different forms and should not be construed as limited to the embodiments set forth herein; rather, these embodiments are provided so that this disclosure will satisfy applicable legal requirements.

### Overall Configuration

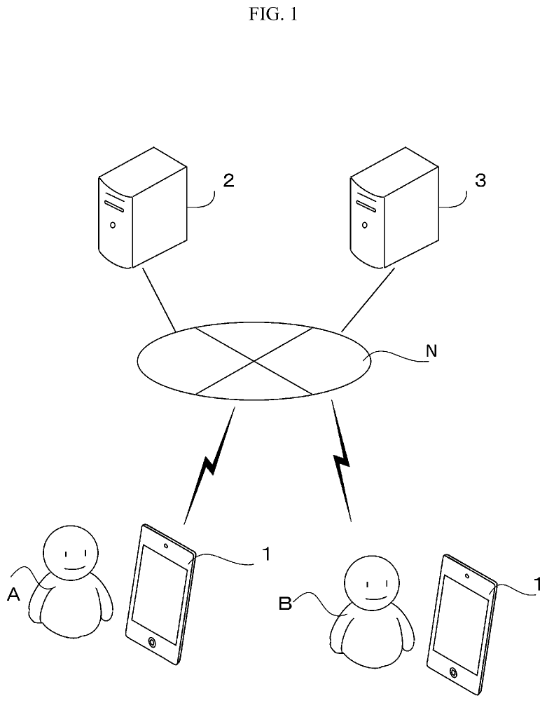

FIG. 1 is a diagram illustrating an overall configuration of a game system according to the present embodiment. As illustrated in FIG. 1, the game system includes player terminals 1 respectively prepared for players A and B of the game, and a game server 2. The player terminals 1 and the game server 2 can be connected to a communication line N, and thus can communicate with each other.

The communication line N is a communication channel that enables data communications. Specifically, the communication line N includes a communication network such as a local area network (LAN) using a private line (private cable) for direct connection, Ethernet (registered trademark), and the like, a telecommunication network, a cable network, and the Internet. The communication method may be a cable communication method or a wireless communication method.

The player terminal 1 is a computer capable of executing a game program, and can perform data communications with the game server 2 by being in connection with the communication line N via a radio communication base station and the like. Examples of the player terminal 1 include a smartphone, a mobile phone, a portable game device, a non-portable game device, an arcade game device, a personal computer, a tablet computer, and a controller of a non-portable game console. Basically, there are a plurality of player terminals 1 operated by respective players.

The game server 2 is a server system including one or a plurality of server apparatuses, storage devices, and the like. The game server 2 provides various services for running the game according to the present embodiment, and can perform management of data required for running the game, distribution of a game program and data required for executing the game on the player terminal 1, and the like.

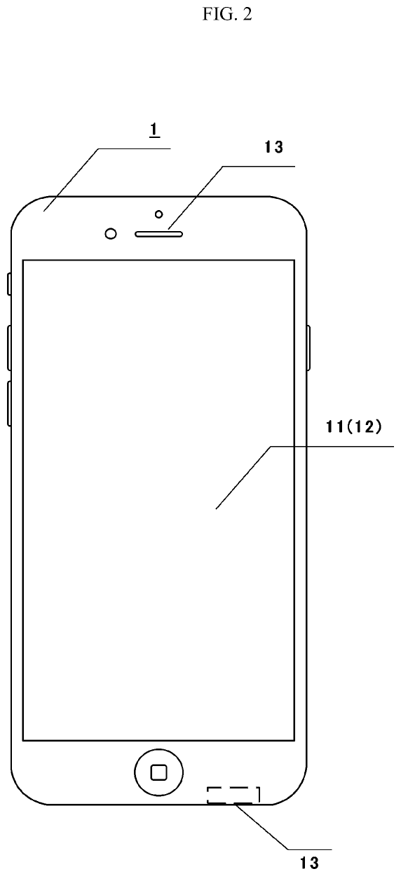

FIG. 2 is a diagram illustrating an example of a device configuration of a smartphone which is an example of the player terminal 1. As illustrated in FIG. 2, the player terminal 1 includes a display 11, a touch operation panel 12 integrally configured with the display 11, and a speaker 13. The player terminal 1 is further provided with unillustrated elements such as a control board, an internal battery, a power button, and a volume control button.

The control board contains a microprocessor of various types (e.g., a central processing unit (CPU), a graphics processing unit (GPU), and a digital signal processor (DSP)), an IC memory of various types (e.g., an application specific integrated circuit (ASIC), a video random access memory (VRAM), a random access memory (RAM), and a read only memory (ROM)), a radio communication module for wirelessly communicating with a mobile phone base station, and the like. The control board further contains what is known as an interface circuit (I/F circuit) such as a driver circuit for the touch operation panel 12. These elements contained in the control board are electrically connected to each other via a bus circuit and the like, to be capable of writing and reading data to and from each other and of exchanging signals.

In the present embodiment, an example is described where the game system described above is applied a competition game using a first game element possessed by a first player A and a first game element possessed by a second player B as an opponent.

This first game element is a virtual or a tangible article associated with a character. An example of the virtual or the tangible article includes a virtual card displayed on a computer or a tangible card. A character that can appear in the executed game in response to the use of the card is assumed to be a character the action of which is controlled based on an operation by the player (including a non-player operated by a computer). The description is given assuming that a card have a graphic (an image representing the outer appearance of the character) of the corresponding character. However, this should not be construed as a limiting sense. It is a matter of course that a card identifying a game element of the executed game is not limited to those configured to enable a game element such as a character to be identified, and may be a card identifying other game elements such as an item, and an exercised effect. The article is not limited to cards, and may be articles other than cards, as long as the game element associated with the article can be identified. For example, the article may be a modeled object such as a figurine having an outer appearance of a game element.

The second game element different from the first game element also participates in the competition game to which the present embodiment is applied. The second game character is a certain character which does not necessarily need to be associated with a virtual or a tangible article.

The second game element uses the first game element owned by the player in the game. The concept of “using the first game element” includes selecting the first game element or determining the action of the character corresponding to the first game element in the game. If the first game element is a card for example, the second game element autonomously or spontaneously (actively) selects a card owned by the player or determines the action (behavior) of a character corresponding to the card, during the competition in the game. In other words, an operation similar to the selection of the first game element or determination of the action of the character corresponding to the card and the like performed by the player is implemented as in the case of the function of a non-player operated by a computer. Still, the second game element is different from the conventional non-players that are operated by the computer on behalf of human players, in that the second game element exists separately and independently from the human player, and uses the first game element possessed by the player. Furthermore, unlike in the case of the conventional non-players, the player and the second game element form a single group.

The second game element has character information. This character information is information about strength (level) in the game and attribute (such as gender and personality) of the second game element. The autonomous or spontaneous (active) action of the second game element (use of the first game element) is influenced by the character information. In other words, the character information is an ability of the second game element, and difference in the ability results in a difference between second game elements in the autonomous or spontaneous (active) behavior (use of the first game element). The character information changes in response to a selection of the second game element, and as the game progresses.

The autonomous or spontaneous (active) action of the second game element described above is implemented based on information given by an AI function of the game server 2. This AI function is obtained by machine learning using training data such as the contents of game progression and their result in many competition games. A method of the machine learning includes but is not limited to deep learning, reinforcement learning, or combination or these.

### Overview of Game Content

Next, an overview of the game will be described using a display screen of the display 11 of the player terminal 1, for facilitating the understanding of the description of embodiment.

In the game according to the present embodiment, players A and B use a virtual game card (hereinafter, simply referred to as “card”) that is the first game element in the game. A plurality of types of the cards are prepared, and are distinguished from each other based on a combination of an ability of a character associated with each card, card attribute, and the like. The card attribute is defined in advance using, for example, a color such as red and blue, a number from 1 to 7, and the like. Each card has a defined ability parameter value such as a level, attack power, and hit point (HP) used in a competition play (battle) with an opponent such as an enemy character controlled by a computer or another player.

At the time of account registration, a minimum number of cards required for a competition play (battle) is given. The cards can be acquired during the game, purchased as a charged item, and acquired by lottery known as “gacha”. Furthermore, the cards can be acquired by obtaining a tangible game card (hereinafter, referred to as a “real card”) and by performing a registration procedure for making the obtained real card usable in the game. Specifically, by performing a registration procedure for the real card, the players A and B can acquire a card of a card type associated with the real card.

Each of the players A and B builds a deck including a predetermined number (40 for example) of the cards he or she owns, to challenge a competition play (battle) using the deck. The competition play (battle) using the deck is about competing with the opponent to win or lose, using the ability parameter values (character information about the first game element) defined for the cards (deck cards) in the deck.

To play the game, each of the players A and B needs to register his or her account, and configure the deck. The deck can be configured on a deck editing menu presented as one of menus displayed by performing a touch operation on a card menu on a home screen and the like. A player with many cards can configure and set a plurality of decks.

Each of the players A and B can acquire the second game element (hereinafter, referred to as “buddy”) by selecting a buddy he or she likes, among a plurality of buddies, at the time of account registration. Then, each of the players A and B and the acquired buddy are in the same group (paired).

When preparation for the battle is completed, the players A and B perform an operation (touch operation) to select a battle menu on the home screen displayed after login. A plurality of competition styles can be selected on the battle menu.

The competition styles of the battle game according to the present embodiment include: a normal competition style in which a human player compete with a human player; and a special competition style in which players in a predetermined relationship or their buddies compete. The special competition style (special competition mode) further includes a friend match and a league match.

The friend match is a competition mode in which players in a predetermined relationship compete, and includes three types of competition styles: player vs player; player vs player's buddy; and player's buddy vs player's buddy. An example of the predetermined relationship in this context includes a friend relationship described later and the like.

The league match is implemented with a player serving as a host inviting players in predetermined relationship with him or her. In this competition mode, the host player and participant players compete with other participant players or the buddy of the host player, in a round-robin group tournament ranking system. When the buddy competes, it uses the deck set by the player paired with the buddy. An example of the predetermined relationship in this context includes friend a relationship described later, an acquaintance relationship over a social networking service (SNS), and the like.

Now, a description will be given on the friend relationship. The friend relationship is established between the player A and another player B when the player A sends a “friend request” to the player B under a predetermined condition or at a predetermined timing, and the player B accepts the “friend request”.

The predetermined condition or timing includes a case where a player him or herself searches for another player using a player ID, a case where a player participates in a predetermined competition (league match, for example), and the like. However, if one becomes capable of sending the “friend request” to other participant players by simply participating in a predetermined competition (league match, for example), “friend request” can be made without the players actually not knowing about each other well. This is against the original spirit of establishing the friend relationship, or might even cause troubles.

In view of this, in the present embodiment, a predetermined limitation is imposed on the “friend request” regarding the relationship among the host and the participants in the league match and the like. Specifically, the league match is implemented by the host and the participant already in the friend relationship or acquaintance relationship over the SNS. Thus, players not yet in the friendship relationship with the host are already in the acquaintance relationship with the host, whereby the “friend request” is allowed to be sent between the host and the participants. On the other hand, the relationship among the participants is not necessarily the acquaintance relationship over the SNS and the like. Thus, the participants are not allowed to send the “friend request” to each other. Such a limitation on the friend request prevents setting of a friend relationship that may be inappropriate.

A battle starts when the any of the normal competition style and the special competition style is selected and the opponent is determined.

The battle proceeds between the player A and the player B (opponent) alternately taking turns. Each turn comprises a plurality of phases such as: a standby phase in which a hand in the deck card is set in a player area of the own player such as a field; a card use preparation phase in which other deck cards and the like are prepared for using the deck cards set; and a competition phase in which an attack is made on the opponent player or a card of the opponent player using the deck cards deployed in the player area.

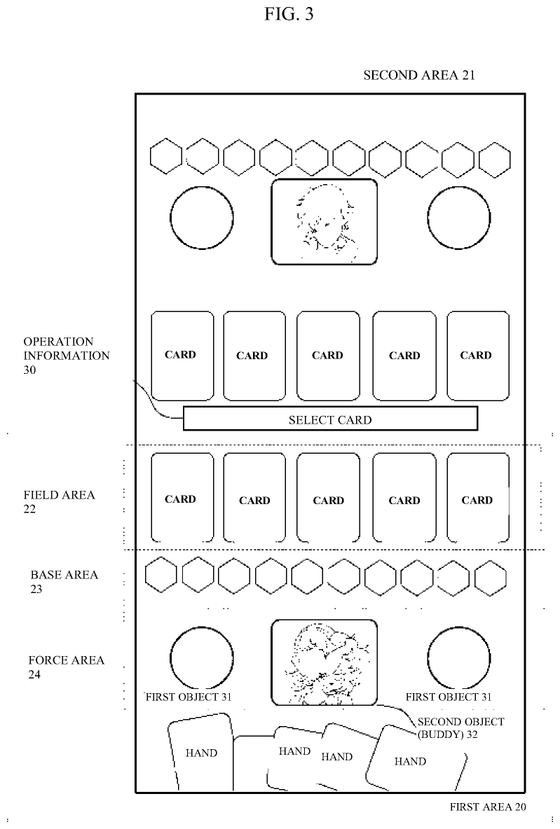

FIG. 3 is diagram illustrating an example of a screen displayed on the display 11 of the player terminal 1, during the standby phase or the card use preparation phase The screen of the display 11 includes a first area 20 in which a card and the like of the player A side are set, and a second area 21 in which a card and the like of the opponent player B are set. Operation information 30 is displayed at the boundary between the first area 20 and the second area 21, to display information about a currently executable operation.

Each of the first area 20 and the second area 21 includes: a field area 22 in which five cards (hand) selected from the own deck are deployed; a base area 23 in which a card consumed (action cost) for exercising the action or the effect of the cards deployed on the field; and a force area 24 in which a first object 31 that has an impact (force) on the exercised effect of the card and has a life (HP) and a second object similarly having a life (HP) are deployed. In the present embodiment, the second object 32 is displayed to represent the player or the buddy as the second game element.

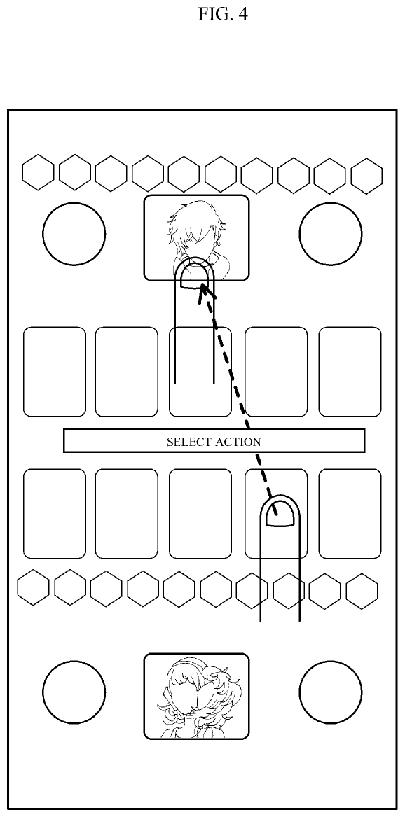

In the competition phase, as illustrated in FIG. 4, the player A uses his or her finger to touch a card used for the attack, and to drag the card to the attack target which is an opponent's card or the first or the second object 31, 32. Thus, the card used for the attack, and the attack target which is a card of the opponent player B or the first or the second object 31, 32 are determined. As a result, the attack by the player A starts. When the buddy A makes an attack, the card used for the attack, and the attack target which is a card of the opponent player B or the first or the second object 31, 32 are determined based on card operation information provided from the game server 2.

This turn including a series of phases are alternately repeated between the player A and the player B that is the opponent. The winner and the loser are determined when the life of any of the players or his or her buddy drops to 0 or when all the cards in the deck are used. The winner and the loser of the competition thus determined (competition result) are presented.

In a case of the competition between the player and the buddy, while the battle screen described above is presented on the human player side, the detailed battle screen may not be displayed and only the competition result may be displayed on the buddy player side. This is due to the peculiarity of the buddy operated by a computer. Specifically, during the competition between the player and the buddy, the buddy side player is not necessarily capable of watching the battle, and a plurality of battles may concurrently occur.

Components for implementing such a game system will be described below.

### Functional Configuration

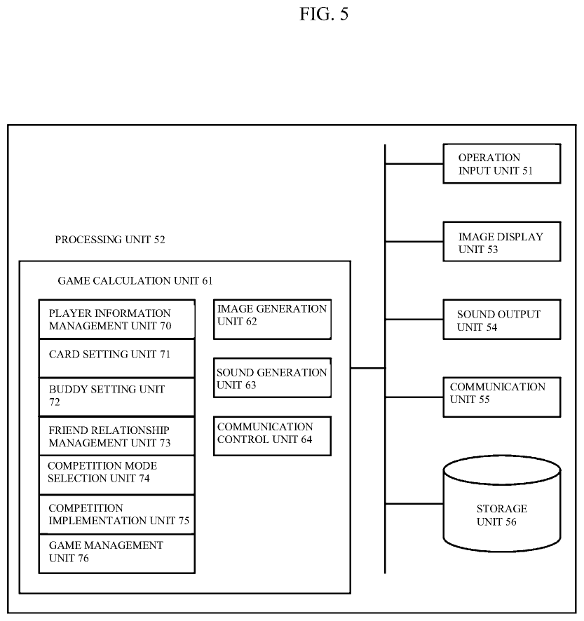

FIG. 5 is a block diagram illustrating an example of a functional configuration of the player terminal 1.

As illustrated in FIG. 5, the player terminal 1 includes an operation input unit 51, a processing unit 52, an image display unit 53, a sound output unit 54, a communication unit 55, and a storage unit 56.

The operation input unit 51 is used by the payer to input various operations related to the game, and outputs an operation input signal, corresponding to the operation input, to the processing unit 52. The function of the operation input unit 51 can be obviously implemented with an element directly operated by a finger of the player A such as a touch operation pad, a home button, a button switch, a joystick, a trackball, and can also be implemented with other elements including elements detecting motions and orientations such as an acceleration sensor, an angular velocity sensor, a tilt sensor, and a geomagnetic sensor. The operation input unit 51 corresponds to the touch operation panel 12 in FIG. 2.

The processing unit 52 performs comprehensive control on an operation of the player terminal 1, based on a program and data stored in the storage unit 56, the operation input signal from the operation input unit 51, and the like. For example, the function of the processing unit 52 can be implemented with electronic parts such as a microprocessor (such as a CPU and a GPU), an ASIC, and an IC memory. The processing unit 52 includes, as main functional units, a game calculation unit 61, an image generation unit 62, a sound generation unit 63, and a communication control unit 64.

The game calculation unit 61 executes various types of game processing to implement the game according to the present embodiment, and outputs the processing result to the image generation unit 62 and the sound generation unit 63. The game calculation unit 61 includes a player information management unit 70, a card setting unit 71, a buddy setting unit 72, a friend relationship management unit 73, a competition mode selection unit 74, a competition implementation unit 75, and a game management unit 76.

The player information management unit 70 uses player data to manage information about the player. The managed information includes basic user information such as a nickname of the player, the rank of the player, and the level of the buddy.

The card setting unit 71 uses card setting data and deck setting data described later, to manage possessed cards currently possessed by the player A, B and the deck. Furthermore, the card setting unit 71 selects the cards to be in the deck and sets the deck in response to the user operation. The card setting unit 71 manages the cards in each deck, and from the deck selected by the player A, B, sets the cards and a hand to be set in his or her field in the standby phase and in the card use preparation phase. Furthermore, the card setting unit 71 generates card setting information that is information about the cards and the hand set in each field, and transmits this information to the game server 2 via the communication unit 55.

The buddy setting unit 72 uses buddy setting data described later, to manage information about the buddy that is the second game element selected by the player A, B, at the time of account registration. The buddy setting unit 71 sets the level of and the character information about the buddy (second game element) to be at initial values (lowest values) at the time of account registration. When the buddy is changed, the buddy setting unit 72 sets the level of and the character information about the buddy (second game element) to be at initial values (lowest values). The buddy setting unit 72 outputs the image information about the buddy to the image generation unit 62, during the competition or while other menu screens are displayed.

The friend relationship management unit 73 uses the friend data to manage the friend relationship. The friend relationship management includes: player search; friend request; and friend acceptance. The player search includes a function of searching for a target player of the friend request, using identification information (player ID) about the player. The identification information about the player is acquired from the target player through direct notification or through other approaches for communications. The friend request is a function of sending a friend request to a player (user) the requester wants to establish the friend relationship with. As described above, the friend request is allowed only when a predetermined condition is satisfied. Friend acceptance is a function of accepting the player (user) who sent the friend request, as a friend. When the player (user) who sent the friend request is accepted as a friend, the player (user) who sent the friend request is registered as a friend.

Furthermore, the friend relationship management unit 73 cooperates with the competition mode selection unit 74 and the competition implementation unit 75 to provide functions of displaying a list of registered friends when each competition mode is selected or when the competition ends, sending the friend request to the selected friend, and accepting a player as a friend.

The competition mode selection unit 74 displays a battle menu, and implements selection of the competition mode by the player. The competition modes displayed on the battle menu include the normal competition mode in which (human) players compete with each other, the friend match mode, and the league match mode. FIG. 6 illustrates an example of the battle menu displayed. The player can select the competition mode by performing an operation of selecting a button (touch operation) of the desired competition mode which is a button 200 for the normal competition mode, a button 201 for the friend match mode, or a button 202 for the league match mode.

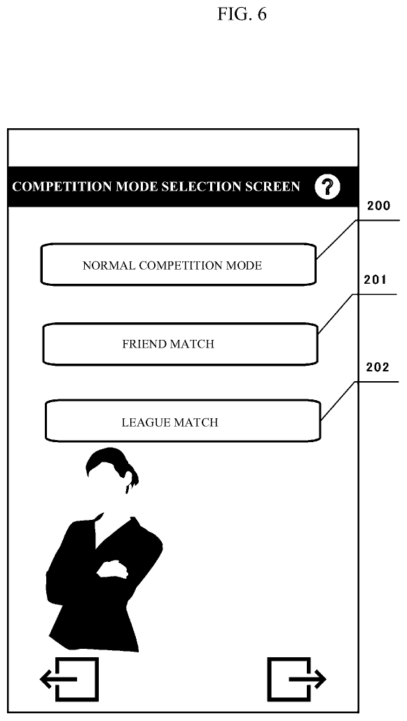

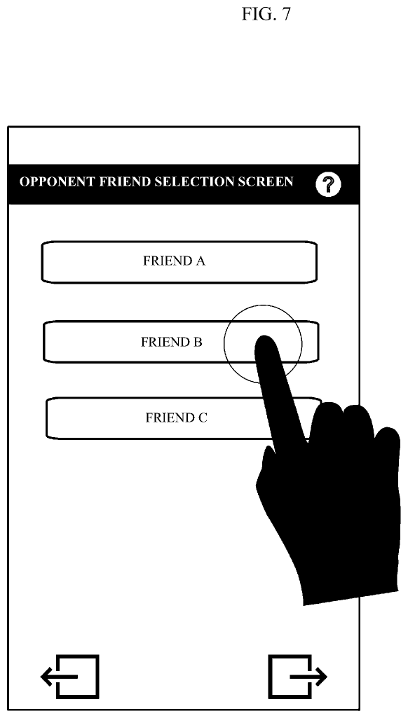

When the friend match mode is selected, as illustrated in FIG. 7, a list of friends in the friend relationship registered by the friend relationship management unit 76 is displayed. When the player touches a button associated with the friend to be the opponent, the competition with the friend starts. It is to be noted that only players in the friend relationship can enter a buddy competition where buddies of the players compete.

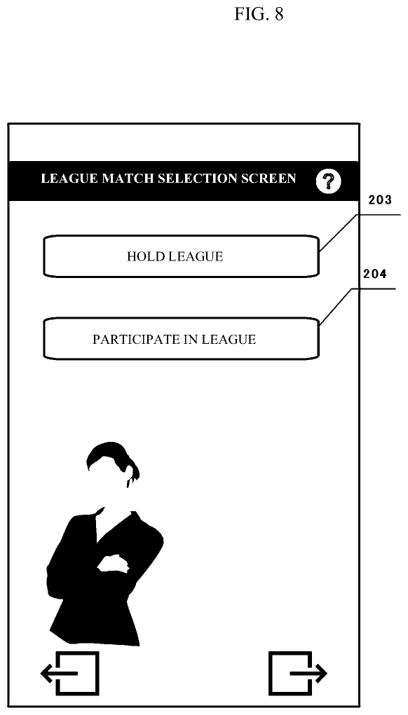

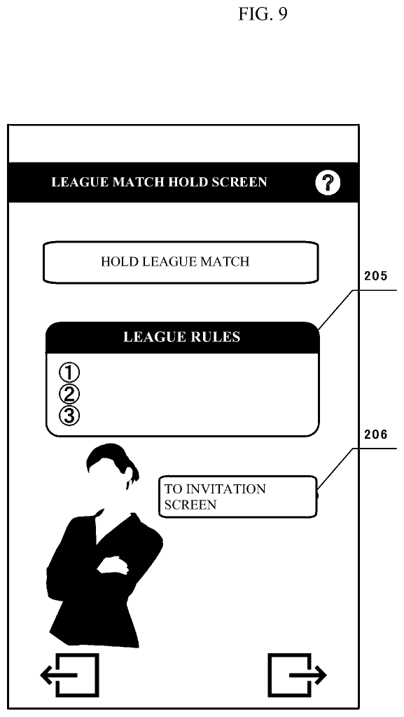

When the league match mode is selected, the competition mode selection unit 74 displays a league match selection screen for selecting whether to hold a league match or to participate in a league match. FIG. 8 illustrates an example of the league match selection screen. The player that holds the league match touches and selects a league match hold button 203. As a result, the screen transitions to a league match hold screen, an example of which is illustrated in FIG. 9.

The player who holds the league match inputs rules for the league he or she holds, on a league rule input screen 205. Then, the player selects an invitation screen button 206 to make the screen transition to an invitation screen for inviting players to the league match he or she holds. When the invitation screen button 206 is selected, the screen transitions to the league match invitation screen, an example of which is illustrated in FIG. 10. The league match invitation screen offers two methods for invitation to the league match. One of the methods includes copying a league code 207 identifying the league match and notifying the acquaintances of the league code using an SNS 209. The other method includes displaying a list of friends in the friend relationship with the player as illustrated in FIG. 11 by touching a friend list button 208, and selecting a friend to be invited to the league match on the list. In this manner, the host off the league match can invite acquaintances (players in the friend relationship or players in the acquaintance relationship over the SNS) to the league match.

The player challenged to a competition in the friend match mode or the player invited to the league match each select a button corresponding to the notified information on the competition mode screen, to be in the competition in any of the modes. When the information notified from the host is identification information about the league match, the player can input the information to participate in the league match.

Each information about the selected competition mode (competition mode selection information) is transmitted to the game server 2 via the communication unit 55.

The competition implementation unit 75 implements the competition based on the operation by the players in each competition mode. Based on the touch operation and the like by the players A and B, the competition implementation unit 75 selects a card, determines the action of the card, generates action selection information that is information about the selection or the action of the card, and transmits the information to the game server 2 via the communication unit 55. The competition implementation unit 75 acquires card operation information that is information related to an operation for the selection or the action of the card, via the communication unit 55. The card operation information is information generated by an AI function of the game server 2 with reference to the character information about a buddy and the status of the card setting information in the competition, for displaying an image where the buddy performs operations for the selection or the action of the card on the player terminal 1. The competition implementation unit 75 executes processing of displaying an image where the buddy performs operation for selection or action of the card by using the acquired card operation information.

The game management unit 76 manages the progress of the game as a whole.

The image generation unit 62 generates one game screen per one frame time ( 1/60 seconds for example) based on the result of the processing by the game calculation unit 61, and outputs an image signal corresponding to the generated game screen to the image display unit 103. The function of the image generation unit 62 can be implemented by, for example, a processor such as a GPU, a DSP, a video signal IC, a program such as a video codec, a rendering frame IC memory such as a frame buffer, an IC memory used for expanding texture data, and the like.

The sound generation unit 63 generates sound information (about sound effect, BGM, and operation assist information related to the game) and a sound signal corresponding to various operation sounds and the like, based on the result of the processing by the game calculation unit 61, and outputs the information and the signal to the sound output unit 54. The function of the sound generation unit 63 can be implemented by a processor such as a DSP and a sound synthesis IC, an audio codec that can replay a sound file, and the like, for example.

The communication control unit 64 executes communication connection and data processing for performing data communications with the game server 2.

The image display unit 53 displays various game screens based on the image signal received from the image generation unit 62. The function of the image display unit 53 can be implemented by a display device such as a flat panel display, a cathode ray tune (CRT), a projector, a head mounted display, for example. The image display unit 62 corresponds to the display 11 in FIG. 2 for example.

The sound output unit 54 outputs sound such as sound effect related to the game, based on the sound signal received from the sound generation unit 63. The sound output unit 54 corresponds to the speaker 13 in FIG. 2, for example.

The communication unit 55 implements communications by connecting to the communication line N. The function of the communication unit 55 can be implemented by a radio communication device, a modem, a terminal adaptor (TA), a jack for a cable for wired communications, a control circuit, and the like.

In the storage unit 56, a program for operating the player terminal 1 and implementing various functions of the player terminal 1, data used while the program is executed, and the like, are stored in advance or temporarily stored every time the processing is executed. The storage unit 56 can be implemented by a RAM, a ROM, an IC memory such as a flash memory, a magnetic disk such as hard disk, an optical disk such as a CD-ROM and DVD, and the like.

The storage unit 56 stores a system program and a game program. The system program is a program for implementing a basic computer function of the player terminal 1. The game program is a program for causing the processing unit 52 to function as the game calculation unit 61. The program is distributed from the game server 2 or another application distribution server, when the account registration by the player is completed.

The storage unit 56 stores card setting data, deck setting data, buddy setting data, player data, and friend data managed by the player information management unit 70. Furthermore, required data (such as model data and texture data, motion data, and effect data for displaying an image of a character corresponding to the card or a buddy, a background image of the game screen, and sound data such as sound effect) are distributed and stored in the storage unit 56.

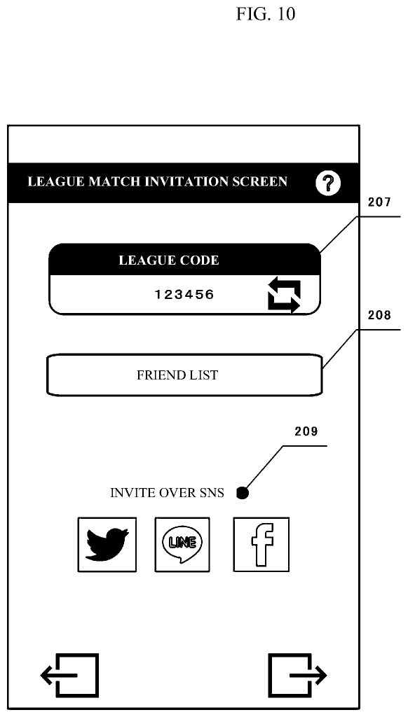

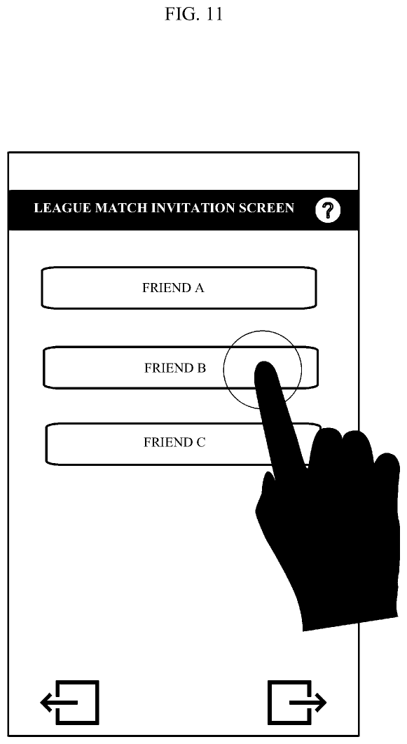

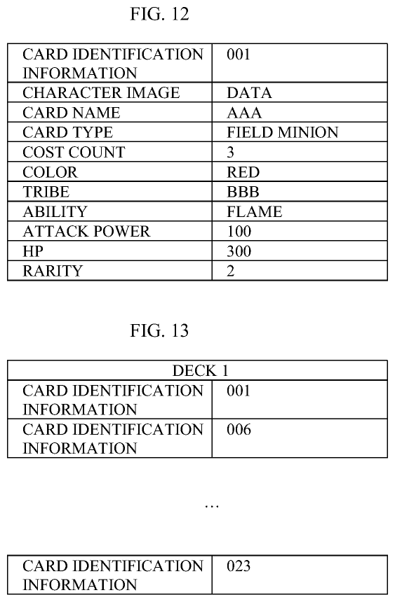

The card setting data is character information about a card possessed by the player, and is prepared for each card type. FIG. 12 is a diagram illustrating an example of the card setting data about a card possessed by the player. FIG. 12 illustrates card setting data about a single card possessed by the player identified by card identification information “001”. The card setting data includes card identification information, image, card name, card type, cost count, color, tribe, ability, attack power, hit point, and rarity. The card setting data illustrated in FIG. 12 is merely an example, and thus the data is not limited to this. The card setting data increases and decreases as the card possessed by the player A, B increases and decreases.

The deck setting data is data about each deck of the player, and includes card identification information about cards in each deck. FIG. 13 is a diagram illustrating an example of the deck setting data. The example illustrated in FIG. 13 is an example of deck setting data about a deck 1 of the player A, and indicates that the deck 1 includes cards identified by card identification information “001” to card identification information “023” in this example. Note that the deck setting data illustrated in FIG. 13 is merely an example, and thus the data is not limited to this.

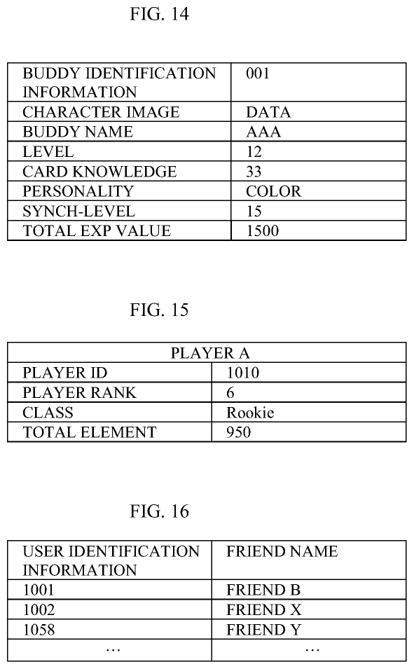

The buddy setting data is character information about a buddy selected by menu setting. This character information about a buddy changes as the game progresses. When the change occurs, character information after the change is notified from the game server 2, and the character information is updated. FIG. 14 is a diagram illustrating an example of buddy setting data for the player A. The buddy setting data of the example in FIG. 14 includes buddy identification information, buddy image, buddy name, level, card knowledge, personality, and synch-level. The buddy setting data in FIG. 14 is merely an example, and thus the data is not limited to this.

The player data is data including identification information (ID), the rank, the class, and current total element (total win points) of the player. FIG. 15 is a diagram illustrating an example of the player data. The data of the example in FIG. 15 includes player ID, the rank, the class, and the current total element of the player A. These types of data are updated by the player information management unit 70 using rank information transmitted from the game server 2 when the competition ends.

The friend data is data including user identification information about another player in the friend relationship with the player and a friend name. FIG. 16 is a diagram illustrating an example of the friend data. The friend data of the example in FIG. 16 is data about the player A.

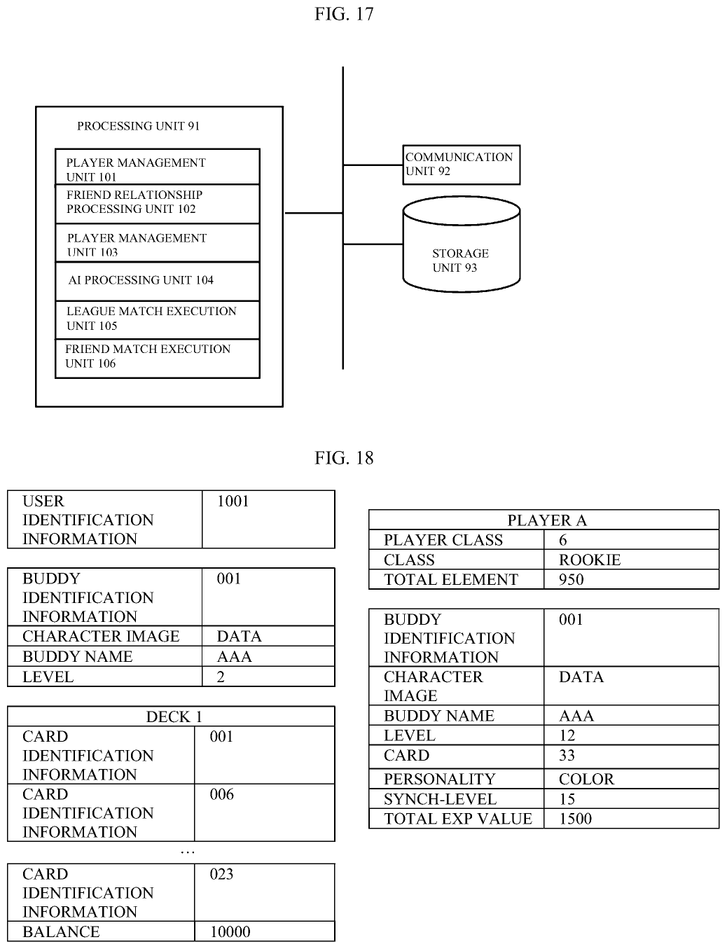

Next, a configuration of the game server 2 will be described. FIG. 17 is a block diagram illustrating an example of a functional configuration of the game server 2.

The game server 2 includes a processing unit 91, a communication unit 92, and a storage unit 93.

The processing unit 91 performs comprehensive control on the operations of the game server 2 based on the program and data stored in the storage unit 93, the information received, and the like. The function of the processing unit 91 can be implemented by electronic parts including a microprocessor such as a CPU and a GPU, an ASIC, and an IC memory. The processing unit 91 includes a player management unit 101, a friend relationship processing unit 102, a game management unit 103, an AI processing unit 104, a league match execution unit 105, and a friend match execution unit 106.

The player management unit 101 manages, for each player terminal 1 connected thereto, the account, a game progress status, and the like, by using user information data described later.

The friend relationship processing unit 102 manages the friend relationship among players by using the friend data, and also manages establishment or failure to establish the friend relationship among players in response to friend acceptance and rejection. Furthermore, the friend relationship processing unit 102 cooperates with the league match execution unit 105 to manage the friend request at the time of notification of the league match result.

The game management unit 103 manages the game as a whole.

The AI processing unit 104 includes an algorithm obtained through machine learning using training data such as the contents of the progression and their results in many competition games. The algorithm corresponds to the level and the character information of the buddy. The machine learning is typically, but without limitation, performed through deep learning. The AI processing unit 104 receives the card setting information, the level of and the character information about the buddy of the player of the player terminal 1, the competition mode, and the like transmitted from the player terminal 1, and outputs card operation information about the buddy under the condition indicated by the card setting information. The algorithm varies depending on the level of and the character information about the buddy. Thus, even when the card setting information transmitted from the player terminal 1 is the same, the card operation information output may vary if the level of and the character information about the buddy of the player vary.

The league match execution unit 105 receives the card setting information, action selection information, and the like from the player terminal 1, uses the card setting information and the action selection information as well as card data described later to execute competition processing for the league match in cooperation with the AI processing unit 104, and outputs the result of the competition. The league match execution unit 105 manages the friend request in cooperation with the friend relationship processing unit 102, at the time of notification of the result of the competition in the league match.

The friend match execution unit 106 receives the card setting information, action selection information, and the like from the player terminal 1, uses the card setting information and the action selection information as well as the card data described later to execute competition processing for the friend match in cooperation with the AI processing unit 104, and outputs the result of the competition.

The communication unit 92 connects the communication line N to implement communications.

The storage unit 93 stores a system program and a game program. The system program is a program for implementing the basic computer function of the game server 2. The game program is a program for causing the processing unit 91 to function as the player management unit 101, the friend relationship processing unit 102, the game management unit 103, the AI processing unit 104, the league match execution unit 105, and the friend match execution unit 106.

The storage unit 93 further stores user information data, card data, and friend data.

The user information data is basic data about a player participating in the game, and is recorded for each player. FIG. 18 is a diagram illustrating an example of the user information data. The user information data of the example illustrated in FIG. 18 includes user identification information about a player, buddy setting data about the player, deck setting data, the rank of the player, class, current total element, the level of the buddy of the player, total EXP value, and the character information (such as card understanding).

The card data is data about all the card used in the game. Basically, data similar to the card setting data illustrated in FIG. 12 described above is stored for all the cards used in the game.

The friend data is data about each friend relationship among all the players in the game. Basically, data similar to the friend data illustrated in FIG. 16 described above is stored for each of player in the game.

### Operation of Each Apparatuses

Next, operations of apparatuses with the configuration described above will be described.

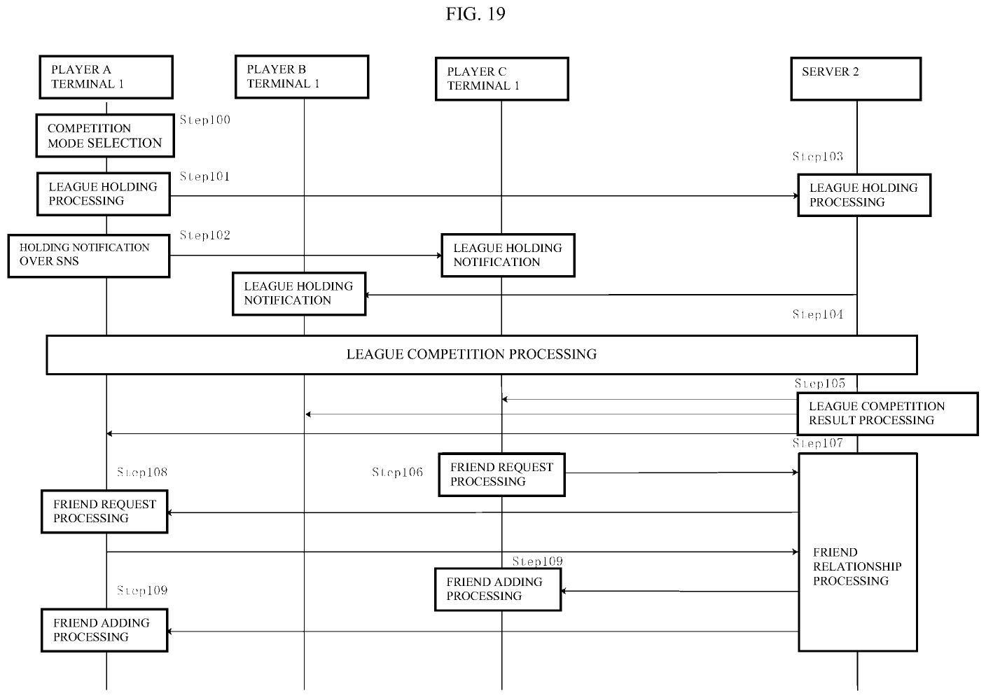

Operations between apparatuses will be described. FIG. 19 is an overall sequence diagram for explaining operations of the player terminal 1 and the game server 2. The description below will be given for an example with three players A, B, and C already registered in the game system. The player A and the player B are in the friend relationship. The player A and the player C are not in the friend relationship but are in the acquaintance relationship over the SNS. The player B and the player C are not in the friend relationship or in the acquaintance relationship over the SNS. The player A is the host of the league match, and the players B and C participate in the league as participants. The description will be given assuming these conditions.

First of all, the player A selects the competition mode to hold the league hosted by the player A. The competition mode selection processing for selecting the competition mode is executed by the competition mode selection unit 74 of the terminal 1 of the player A (Step 100).

The competition mode selection unit 74 displays the competition mode selection screen as illustrated in FIG. 6. The player A touches the league match button 202 to select the league match. The competition mode selection unit 74 displays the league selection screen as illustrated in FIG. 8. The player A touches the league hold button 203 to hold the league.

When the league hold button 203 is touched, the competition mode selection unit 74 executes league holding processing (Step 101). The competition mode selection unit 74 displays the league match hold screen as illustrated in FIG. 9. The player A inputs the league rule to the league rule input screen 205, and touches the invitation screen button 206 to select the players to be invited to the league.

The competition mode selection unit 74 displays the league match invitation screen as illustrated in FIG. 10. The player A can invite players to the league held by the player A by two methods. One of the methods is a method of notifying the league code identifying the held league using an SNS. The other method is a method of selecting friends of the player A from the friend list, and issuing a notification to them. In this example, to invite the player B to the league, the player A touches the friend list button 208 to display the friend list as illustrated in FIG. 11, and selects the friend B. As a result, the competition mode selection unit 74 transmits league holding information including the league rule of the league hosted by the player A and the information about the friend B invited to the league, to the server 2. On the other hand, the player A notifies the player C of the league code using the SNS (Step 102).

The server 2 receives the league holding information. The league competition implementation unit 105 of the server 2 executes league holding processing (Step 103). In the league holding processing, the friend information about the invitees included in the league holding information is used to notify the players invited to the league that the league will be held by the player A and that the players are invited. In this example, the league competition implementation unit 105 transmits league holding notification to the player B. Then, the processing proceeds to the league competition processing (Step 104).

The competition mode selection unit 74 of the terminal 1 of the player B receives the league holding notification, and displays information indicating that the league is held by the player A and that the player B is invited to the league. To participate in the league held by the player A, the player B touches a league participate button 204 in the league match selection screen in FIG. 8 to participate in the league held by the player A.

On the other hand, to participate in the league held by the player A, the player C that has received the league code touches the league participate button 204 in the league match selection screen in FIG. 8, and inputs the league code on the league code input screen subsequently displayed to participate in the league held by the player A.

The league competition implementation unit 105 of the server 2 implements the competition between the participating players. Each competition is a competition between the participating player and a buddy of the participating player. In this example, the player A competes with the buddy of the player B and the buddy of the player C. Similarly, the player B competes with the buddy of the player A and the buddy of the player C. Similarly, the player C competes with the buddy of the player A and the buddy of the player B. In this manner the competition is implemented. It is to be noted that the deck used by the buddy is the same as the deck used by the player paired with the buddy.

When all the competitions end or the held period ends, the league competition implementation unit 105 transmits the competition result of the league to the terminal 1 of each of the players A, B, and C (Step 105). It should be noted that the content transmitted to the player A is different from those transmitted to the players B and C. Specifically, the league competition implementation unit 105 transmits the competition result of the league and the friend request information enabling the friend request to be sent to the league participants (not including that participants already in the friend relationship). On the other hand, the league competition implementation unit transmits the competition result of the league and the friend request information enabling the friend request to be sent to the league host only, to the players B and C.

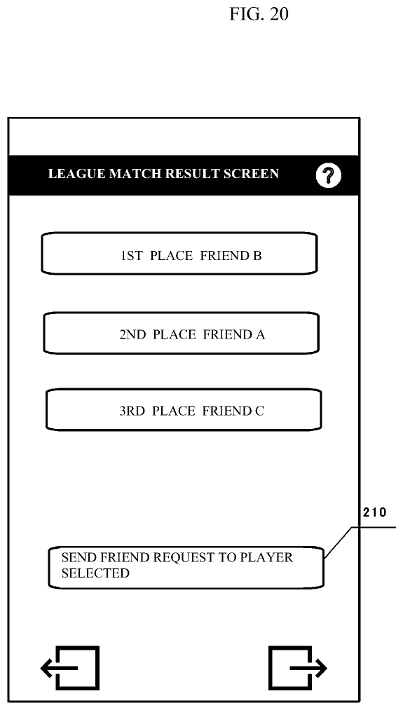

The terminal 1 of the player A receives the league competition result. Then, the friend relationship management unit 73 executes friend request processing (Step 106). The friend relationship management unit 73 displays the competition result. In FIG. 20, the players participated in the league are displayed in order of the competition result, and the friend request button for sending the friend request is displayed to each participant. For example, to send the friend request to the player C who is not a friend yet, the player A touches the button associated with the player C, and then touches the friend request button 210 to send the friend request (Step 106).

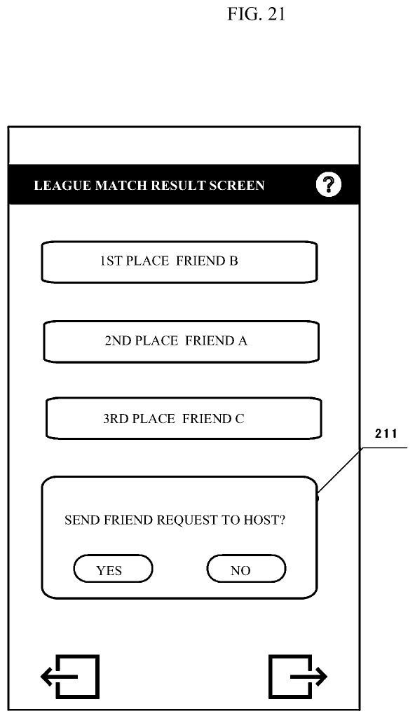

Meanwhile, the terminal 1 of the player B, C receives the league competition result. Then, the friend relationship management unit 73 executes the friend request processing (Step 106). The friend relationship management unit 73 displays the competition result. FIG. 21 illustrates an example of what is displayed on the terminals 1 of the players B and C. In FIG. 21, the players participated in the league are displayed in order of the competition result, and the friend request button 211 for transmitting the friend request to the host is displayed. For example, when sending the friend request to the player A who is the host and is not yet a friend, the player B, C touches the friend request button 211 to send the friend request. Thus, the players B and C can send the friend request only to the player A who is the host, and cannot send the friend request to other participating players.

When the server 2 receives the friend request, the friend relationship processing unit 102 sends the friend request to the player that is the target of the friend request (Step 107).

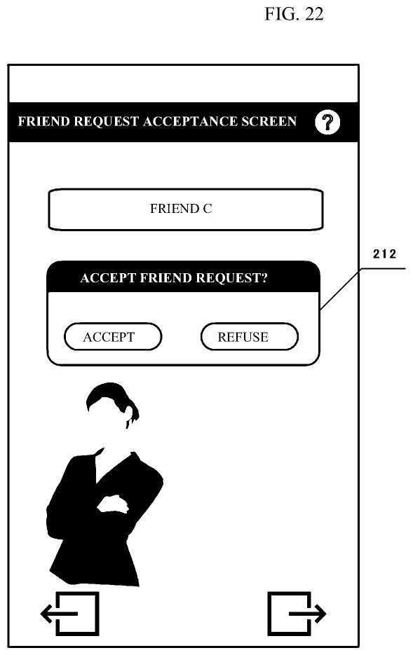

Upon receiving the friend request, the friend relationship management unit 73 of the terminal 1 of each player executes friend acceptance processing (Step 108). The friend relationship management unit 73 displays a friend request acceptance screen. FIG. 22 illustrates an example of the friend request acceptance screen. The player touches the friend accept button to accept the friend request. Then, the friend relationship management unit 73 transmits friend acceptance information to the server 2.

The server 2 receives the friend acceptance information. The friend relationship processing unit 102 of the server 2 establishes the friend relationship. When the friend relationship is established, the identification information about the player who accepted the friend request is added to the friend lists of the players who sent and accepted the friend request. The identification information about the player added is transmitted to the terminals 1 of the players who sent and accepted the friend request.

The friend relationship management units 73 of the terminals 1 of the players who sent and accepted the friend request update the friend lists (Step 109).

Thus, the friend relationship is newly established between the players A and C. Thereafter, each of the players A and C can select the other player as an opponent of the friend match.

This ends the description the operation for overall game progression.

With the present embodiment, the condition under which the friend request can be made is limited to prevent trouble between user that are players can be prevented, to eliminate a factor that may make the game unentertaining.

In the embodiment described above, an example of the card game using virtual game cards is described, but the genre of the applicable game is not limited. For example, the game may be a sport competition game with a character associated with the first game element being an athlete.

A part or entirety of the embodiment described above can be described as the following notes, but the invention is not limited to the following notes.

### Note 1

An information processing apparatus to execute a competition game using a first game element, the information processing apparatus including a memory storing an execution instruction, and a processor,

the processor executing, with the execution instruction,

relationship setting processing capable of setting a first relationship or a second relationship between own player and another player; and

relationship control processing capable of performing control to enable setting of a third relationship between the own player and another player in the first relationship with the own player, and to disable the setting of the third relationship between the own player and another player in the second relationship with the own player.

### Note 2

An information processing apparatus to control a competition game using a first game element, the information processing apparatus including a memory storing an execution instruction, and a processor,

the processor executing, with the execution instruction,

relationship setting processing capable of setting a first relationship between players of a game or a second relationship between the players; and

control processing capable of performing control to enable setting of a third relationship between the players in the first relationship and to disable the setting of the third relationship between the players in the second relationship.

The present invention is described above based on a preferred embodiment. It should be noted that the present invention is not necessarily limited to the embodiment described above, and can be modified in various ways without departing from the technical idea thereof.

1. A program control apparatus, comprising at least one processor and at least one non-volatile computer readable medium comprising computer code, the at least one non-volatile memory and the computer code configured to, with the processor, cause a computer to execute a competition game using a first game element, and to cause the computer to:
set a first relationship or a second relationship between a first player and another player; and
perform control to enable setting of a third relationship between the first player and another player in the first relationship with the first player, and to disable the setting of the third relationship between the first player and another player in the second relationship with the first player.

2. The program control apparatus according to claim 1, wherein
the first relationship is a relationship between a host of a first competition game and a participant of the first competition game,
the second relationship is a relationship between the participant of the first competition game and another participant of the first competition game, and
the third relationship is a friend relationship.

3. The program control apparatus according to claim 1, further causing the computer to:
issue a request to be in the third relationship to another player; and
accept the request to be in the third relationship from another player.

4. The program control apparatus according to claim 3, wherein when the request to be in the third relationship is accepted, the third relationship between the player that has issued the request and the player that has accepted the request is set.

5. The program according to claim 1 further causing the computer to:
set a deck including the first game element, and
set a second game element that is grouped with the first player and is capable of using the deck.

6. The program according to claim 5, wherein the first competition game comprises a competition between players, including the host and a player as the participant, and the second game element of the host and another player as the participant.

7. The program according to claim 5 further causing the computer to enable the host of the first competition game to set a condition for the first competition game, wherein the condition for the first competition game comprises whether an advice is proposed using the second game element in accordance with progress of the game.

8. The program according to claim 1 further causing the computer to select a second competition game in which only players in the third relationship are able to compete.

9. The program according to claim 8, wherein the second competition game comprises a competition between the second game element of the first player and the second game element of another player in the third relationship with the first player.

10. An information processing apparatus to execute a competition game using a first game element, the information processing apparatus comprising:
a relationship setting unit capable of setting a first relationship or a second relationship between a first player and another player; and
a relationship control unit capable of performing control to enable setting of a third relationship between the first player and another player in the first relationship with the first player, and to disable the setting of the third relationship between the first player and another player in the second relationship with the first player.

11. An information processing apparatus to control a competition game using a first game element, the information processing apparatus comprising:
a relationship setting unit capable of setting a first relationship between players of a game or a second relationship between the players; and
a control unit capable of performing control to enable setting of a third relationship between the players in the first relationship and to disable the setting of the third relationship between the players in the second relationship.

12. A game system comprising at least one processor and at least one non-volatile computer readable medium comprising computer code, the at least one non-volatile memory and the computer code configured to, with the processor:
issue a request for setting a first relationship between players of a game or a second relationship between the players;
set the first relationship between the players of the game or a second relationship between the players in response to the request; and
perform a controlling operation to enable setting of a third relationship between the players in the first relationship and to disable the setting of the third relationship between the players in the second relationship.
